(19) United States
(12) Patent Application Publication
(10) Pub. No.: US 2022/0042649 A1
(43) Pub. Date: Feb. 10, 2022

(54) DEVICE AND METHOD FOR FILLING WITH LIQUEFIED GAS

(71) Applicant: L'Air Liquide, Societe Anonyme pour I'Etude et I'Exploitation des Procedes Georges Claude, Paris (FR)

(72) Inventors: Yan PENNEC, Sassenage (FR); Guillaume PETITPAS, Jouy-En-Josas (FR)

(73) Assignee: L'Air Liquide, Societe Anonyme pour l'Etude et l?Exploitation des Procedes Georges Claude, Paris (FR)

(21) Appl. No.: 17/393,595

(22) Filed: Aug. 4, 2021

(30) Foreign Application Priority Data
Aug. 5, 2020 (FR) FR 2008283

(51) Int. Cl. F17C 5/02

(52) U.S. Cl. CPC F17C 5/02; F17C 2223/0153; F17C 2225/0153; F17C 2205/0332; F17C 2221/03; F17C 2250/043; F17C 2265/065; F17C 2205/0367; F17C 2221/012

(57) ABSTRACT

Device for filling with liquefied gas comprising a fluid circuit provided with a first pipe for liquid transfer comprising a first end that is intended to be connected to a source of liquefied gas and a second end that is intended to be connected to a tank to be filled, a second pipe for gas transfer comprising a first end that is intended to be connected to the source of liquefied gas and a second end that is intended to be connected to said tank to be filled, the circuit comprising at least one third transfer pipe connecting the first and second transfer pipes, and a vent device connected to the first and second transfer pipes via a set of one or more safety valves, the circuit comprising a set of one or more valves for controlling the streams of fluid in the pipes of the circuit, the device comprising a system for gas flushing of the circuit, characterized in that the flushing system comprises a first source of pressurized gas, and a first set of one or more flushing pipes connecting the first source of pressurized gas in parallel both to the first and second transfer pipes via a set of one or more valves.

### CROSS-REFERENCE TO RELATED APPLICATIONS

This application claims the benefit of priority under 35 U.S.C. § 119 (a) and (b) to French patent application No. FR 2008283, filed Aug. 5, 2020, the entire contents of which are incorporated herein by reference.

### BACKGROUND

### Field of the Invention

The invention relates to a device and a method for filling with liquefied gas, in particular liquid hydrogen.

The invention relates more particularly to a device for filling with liquefied gas comprising a fluid circuit provided with a first pipe for liquid transfer comprising a first end that is intended to be connected to a source of liquefied gas and a second end that is intended to be connected to a tank to be filled, a second pipe for gas transfer comprising a first end that is intended to be connected to the source of liquefied gas and a second end that is intended to be connected to said tank to be filled, the circuit comprising at least one third transfer pipe connecting the first and second transfer pipes, and a vent device connected to the first and second transfer pipes via a set of one or more safety valves, the circuit comprising a set of one or more valves for controlling the streams of fluid in the pipes of the circuit, the device comprising a system for gas flushing of the circuit.

### Related Art

Currently, filling with cryogenic fluid generally takes place by means of transfer between two tanks, either with the aid of a transfer pump or by means of a difference in pressure (which is positive between downstream and upstream). For example, a liquefied natural gas station can be filled from a tanker truck on which a transfer pump is located. The same is true for fluids such as liquid nitrogen or liquid oxygen. For cryogenic liquids with very low densities such as hydrogen or helium, a simple difference in pressure makes it possible to achieve sufficient flow rates. In the majority of cases, an overpressure is created in the downstream tank by vaporizing some of the fluid. The installation of the downstream (or “customer”) tank provides a plurality of functions: molecule storage, pressurization with the aid of a vaporizer in order to provide the molecule to the application of the customer at the appropriate pressure and flow rate, heating the molecule at the tank outlet, inerting the transfer lines (between the truck and the stationary tank) before and after the transfer. It is thus necessary to have on site (at the “customer” location) gaseous hydrogen and nitrogen and the associated controls (valves, safety members, piping, etc.), a system for discharging residual gas through a vent of which the outlet is generally situated above the tank, a connection to ground, a supply of instrument gas for the safety aspects, etc. The majority of cryogenic installations are stationary systems of significant size (a few m3 to several tens of m3).

Current architectures and methods, the vast majority of which are industrial, are not appropriate for use on board a vehicle. This is because transposing all the aforementioned functions of a stationary installation to the vehicle would lead to constraints that are too strong in terms of additional onboard mass and volume.

Inerting the lines between a truck and the tank requires a time that is too long for rapid filling (more than 30 minutes). One of the impediments to the development of onboard liquefied hydrogen technologies is in part due to the absence of filling solutions that are easy to deploy and meet the requirements: inerting and purging all of the (flexible or fixed) lines and components of the system, discharging the air by means of a dry inert gas (nitrogen, argon, helium, etc.), filling these lines with gaseous helium or hydrogen in order to avoid other molecules freezing. Another requirement is controlling the cold spots of the circuit so as to contain the formation of liquid air (in particular oxygen) and contact thereof with flammable substances. Another requirement is precisely controlling the injection temperature of the liquefied gas. Another requirement is a dedicated vent system. Another requirement is the possibility of flexibility in the filling method: either a single filling line (filling referred to as “bilateral” filling), or with two filling lines: one for the incoming liquid, the other for the exiting gas (filling referred to as “unilateral” filling). Another requirement is centralized control at a single location and in particular safety (isolation of the main tank) via a centralized stop button, simple manipulation of the valves (non-manual manipulation if possible since manual cryogenic valves are generally difficult to actuate). An additional requirement is to be able to decouple (separate) the functions of the device (storage and delivery, on the one hand) and the ancillary functions on the other hand (such as inerting, or discharging residual fluid on the other hand).

### SUMMARY OF THE INVENTION

An aim of the present invention is to overcome all or some of the aforementioned drawbacks of the prior art.

To this end, the device according to the invention, which is otherwise in accordance with the generic definition thereof given in the above preamble, is essentially characterized in that the flushing system comprises a first source of pressurized gas, and a first set of one or more flushing pipes connecting the first source of pressurized gas in parallel both to the first and second transfer pipes via a set of one or more valves.

Furthermore, embodiments of the invention can comprise one or more of the following features:
the flushing system comprises a second source of pressurized gas, and a second set of one or more flushing pipes connecting the second source of pressurized gas in parallel both to the first and second transfer pipes via a set of one or more valves,
the flushing system comprises a third source of pressurized gas, in particular hydrogen, and a third set of one or more flushing pipes connecting the third source of pressurized gas in parallel both to the first and second transfer pipes via a set of one or more valves,
the flushing system comprises a suction member, in particular a vacuum pump, and a fourth set of one or more flushing pipes connecting the suction member both to the first and second transfer pipes via a set of one or more valves,
the flushing system comprises at least one pipe that is common to all or some of the sets of one or more flushing pipes,
the first pipe for liquid transfer comprises an isolation and/or flow control valve,
the one or more sets of one or more flushing pipes are connected to the first transfer pipe on one side or on either side of the isolation and/or flow control valve of the first pipe for liquid transfer,
the first pipe for liquid transfer comprises a liquid-gas mixer, the device comprising a gas source and a gas injection pipe that connects the gas source to the mixer and is provided with a set of one or more valves,
the device is disposed in a casing or housing, the ends of the first pipe for liquid transfer and the ends of the second pipe for gas transfer being connected to the housing by removable connectors,
the device comprises a source of liquefied gas connected to the first end of the first pipe for liquid transfer and to the first end of the second transfer pipe,
the second transfer pipe comprises a pressure regulating valve,
the pressure regulating valve of the second transfer pipe is configured to control the pressure in the tank to be filled during filling thereof, by controlling the pressure of the gas stream leaving the tank via this second transfer pipe.
the pressure regulating valve of the second transfer pipe can be closed so as to allow the transfer pipe (6) to be isolated, in particular for the purposes of inerting and/or leaktightness tests.

The invention also relates to a method for filling a cryogenic fluid tank with liquefied gas using a device according to any one of the features above or below, the method comprising a step of connecting the tank to the second ends of the first and second transfer pipes, the method comprising a step of transferring liquid into the liquid tank via the first pipe for liquid transfer.

According to other possible particular features, the method comprises at least one of the following steps:
regulating the flow rate of liquid transferred into the tank,
discharging a flow of gas from the tank towards the source via the second transfer pipe,
heating the stream of liquid transferred into the tank during the transfer step by injecting a determined quantity of gas into said stream of liquid,
discharging excess pressurized gas in the circuit via the vent device.

The invention can also relate to any alternative device or method comprising any combination of the features above or below within the scope of the claims.

### BRIEF DESCRIPTION OF THE FIGURES

Further particular features and advantages will become apparent upon reading the description below, which is provided with reference to the figures, in which:

FIG. 1 shows an overall schematic and partial view illustrating an exemplary configuration and use of the filling device according to the invention,

FIG. 2 shows a schematic and partial view illustrating an exemplary internal configuration and use of the filling device according to the invention,

FIG. 3 shows a schematic and partial view illustrating a detail of a mixer of the filling device according to the invention.

### DETAILED DESCRIPTION OF THE INVENTION

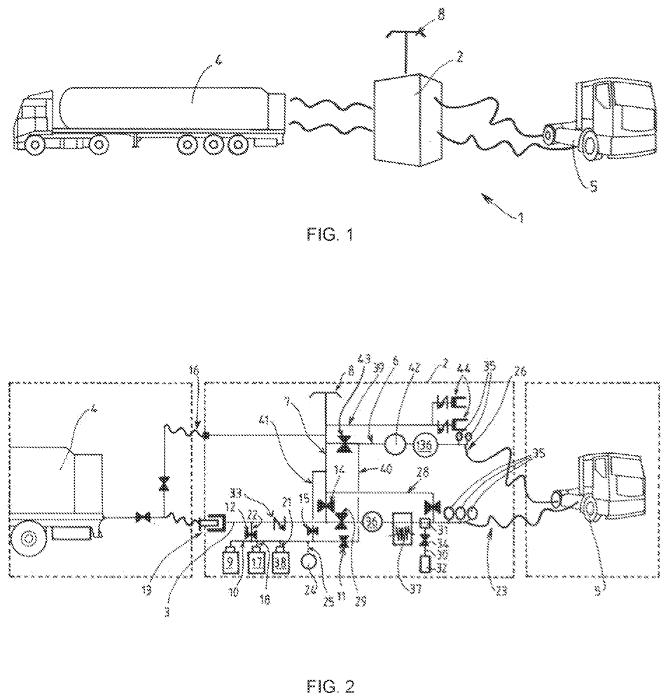

As illustrated in FIG. 1 and FIG. 2, the device 1 for filling with liquefied gas comprises for example circuitry and members or functions housed in a (fixed or mobile) housing 2 or casing. This assembly 2 can in particular constitute a filling station to which a tank 4 that is a source of liquid (supply truck, for example) and a tank 5 to be filled (truck of which the tank is to be filled, for example) are connected.

The connectors are preferably of the quick connector type and the cryogenic connectors can be of the “Johnston” type or any other appropriate technology. In particular at or near these connectors, safety systems with one or more self-closing (breakaway) valves can be provided in case of accidental pulling.

This means that this assembly 2 forms an interface between a tank 4 that is preferably mobile (the delivery tanker, for example) and the application (vehicles 5 to be filled, for example).

As can be seen in FIG. 2, the device comprises a fluid circuit provided with a first pipe 3 for liquid transfer comprising a first end 13 intended to be connected to a source 4 of liquefied gas (in particular to the liquid phase of a supply tank), and a second end 23 intended to be connected to a tank 5 to be filled (in particular to its liquid phase).

The source 4 typically comprises a store of liquefied gas surmounted by a gaseous phase. The source is or can be pressurized, it being possible for this pressure to be the force that drives the fluid to be transferred. A transfer pump may also be envisaged.

The circuit comprises a second pipe 6 for gas transfer, comprising a first end 16 intended to be connected to the source 4 of liquefied gas (for example to its gaseous phase), and a second end 26 intended to be connected to said tank 5 to be filled (for example to its gaseous phase).

The circuit comprises at least one third transfer pipe 7 connected to the first 3 and second 6 transfer pipes and provided with a valve 14. This third pipe 7 is provided in particular so as to collect vent gases towards a discharge means (vent device 8 described below).

The device also comprises a vent device 8 connected to the first 3 and second 6 transfer pipes via a set of one or more safety valves that are not shown (valves that are sensitive to pressure and configured to discharge an abnormal overpressure in the circuit towards the vent 8). The discharge vent 8 is preferably situated above the device but can be offset if necessary. It may also be used for depressurizing the tanks 4 and 5.

The circuit comprises a set of one or more valves for controlling the streams of fluid in the pipes of the circuit. For example, the first pipe 3 for liquid transfer comprises a flow control and/or isolation valve 29.

This architecture permits single-stream (first liquid pipe 3 only) or double-stream (first pipe 3 transferring liquid and second pipe 6 discharging gas) filling of the tank 5.

The circuit can also comprise a line 39 having one end connected to the vent device 8 (or to the third pipe 7) and one or more ends 44 provided with connection members intended to be connected for example so as to receive the second ends 23 and 26 when they are not connected to a tank 5 to be filled. In the configuration in which the second ends 23 and 26 are connected to the ends 44, it is also possible to precool the lines, and/or to de-ice the ends 23, 26 and 44 in order to avoid the formation of ice and/or so as to dry the connectors.

The isolation and/or flow control valve 29 is used to control the main flow rate of fluid (in particular liquid) from the tank 4 to the tank 5. The isolation and/or flow control valve 29 can be used to control the gaseous return of the tank 5 to be filled (if filling using only a single stream) and/or to depressurize the tank 5 before filling. This isolation and/or flow control valve 29 can also be used for the purposes of inerting, and/or to perform leaktightness tests on all or part of the circuit.

On the return line 6, a pressure regulator 42 (preferably a pressure control valve) can be provided to make it possible to control the pressure in the tank 5 during filling (return stream from the tank 5). This pressure regulator 42 can if appropriate also act as isolation valve, just like the valve 43 that can be provided in series for the purposes of inerting and/or leaktightness tests.

This return pressure control valve 42 can be used for inerting by dilution and detecting leaks in the circuit, the one or more tanks or the one or more connectors of the filling nozzles.

The device comprises a system for gas flushing of the circuit for the purposes of inerting, purging or leaktightness pressure testing.

The flushing system comprises a first source 9 of pressurized gas, in particular nitrogen, and a first set of one or more flushing pipes 10, 22, 7, 41, 40, 28 connecting the first source 9 of pressurized gas in parallel both to the first 3 and second 6 transfer pipes via a set of one or more valves 11, 12, 14, 15.

The flushing system preferably comprises a second source 17 of pressurized gas, in particular helium or hydrogen, and a second set of one or more flushing pipes 18, 7, 22, 40, 41, 28 connecting the second source 17 of pressurized gas in parallel both to the first 3 and second 6 transfer pipes via a set of one or more valves 11, 12, 14, 15. This second source 17 can be used for inerting and/or heating all or part of the circuit and in particular the pipe 3 for transferring cryogenic liquid (temperature typically lower than 80K).

The flushing system preferably comprises a third source 38 of pressurized gas, in particular hydrogen, and a third set of one or more flushing pipes 21, 7, 22, 40, 41, 28 connecting the third source 38 of pressurized gas in parallel both to the first 3 and second 6 transfer pipes via a set of one or more valves 11, 12, 14, 15.

The flushing system can also comprise a suction member 24, in particular a vacuum pump, and a fourth set of one or more flushing pipes 7, 22, 40, 41, 28 connecting the suction member 24 both to the first 3 and second 6 transfer pipes via a set of one or more valves 11, 15, 12, 14.

As illustrated, the flushing system can comprise at least one pipe that is common to all or some of the sets of one or more flushing pipes.

This architecture makes it possible to easily inert by flushing and/or dilution all or part of the circuit with one of the aforementioned gases for operations of leaktightness testing or purging or evacuation, for example. One or more of the flushing pipes can also be used to depressurize the tank 5 (for example before filling using only a single stream) and/or to cool all or some of the pipes of the system.

As illustrated, the one or more sets of one or more flushing pipes are preferably connected to the first transfer pipe 3 on either side of the isolation and/or flow control valve 29 of the first pipe 3 for liquid transfer. This valve 29 can in particular be configured to control the flow rate of liquid entering the tank of the vehicle 5 to be filled. A flowmeter 36 can in particular be provided downstream on the pipe 3 so as to control the valve 29 (integrated mass flow controller for example). The valve 29 is preferably controlled remotely and can be of the needle valve type, for example. The quantity of return gas (returning from the tank 5 to be filled via the second transfer pipe 6) can be measured for example by a second flow rate measurement means 136 if need be disposed on the second pipe 6 (for example a mass flowmeter). This flow rate measurement means 136 can have one or more flowmeters in parallel in order to increase its flow rate measurement range and/or optimize the passage of the fluid for the requirements of precooling the tank 5 to be filled, or to allow precise detection of the end of filling.

A non-return valve 33 can be provided on the first transfer pipe 3, for example between the first end 13 and the isolation and/or flow control valve 29.

Likewise, a non-return valve can be provided on the second transfer pipe 6 (not shown for the sake of simplicity).

This allows separate and independent flushing of the parts of the circuit at the first ends 13, 16 or at the second ends 23, 26.

In particular, this circuit and valves architecture allows, for example, inerting of the first pipe 3 for liquid transfer between the liquid source 4 and the isolation/control valve 29. This architecture also allows flushing (inerting) of the circuit situated in the casing or station 2 and of the vent circuit as far as the vent 8. This architecture also allows flushing (inerting) of the circuit in the downstream part (circuit at the tank 5 to be filled) and if appropriate inerting of this tank 5.

This architecture also allows flushing (inerting) of the entire circuit.

Likewise, this architecture makes it possible to precool all or part of the circuit or of the tank 5 to be filled.

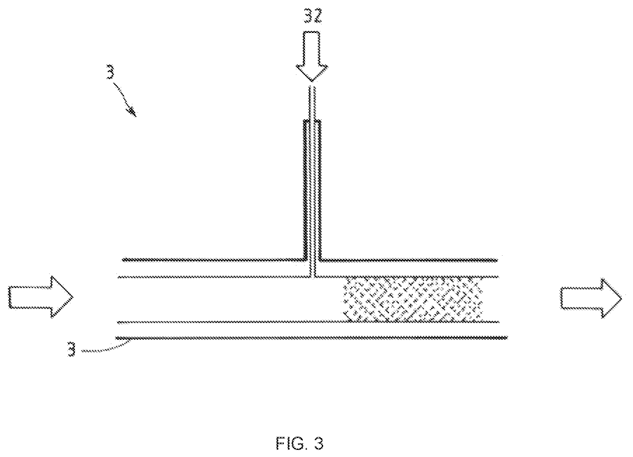

As illustrated, the first pipe 3 for liquid transfer preferably comprises a liquid-gas mixer 31 and a gas source 32 and a gas injection pipe 30 that connects the gas source 32 to the mixer 31 and is provided with a set of one or more valves 34. This allows heating of the entering liquid flow with a stream of gas in order to provide saturation conditions (minimum pressure in the downstream tank). An exemplary mixer is illustrated schematically in FIG. 3. Pressurized gas (for example hydrogen at 300K and 5 to 10 bar) is injected via a transverse pipe into the first liquid pipe 3 (which pipe is preferably thermally insulated in a vacuum) that conveys liquid (for example liquid hydrogen at 21K and a pressure between 5 and 10 bar). The resulting downstream mixture can have a determined temperature, for example of 28K, and a similar pressure between 5 and 10 bar. If appropriate, the vaporization gas from one of the tanks can be put to profitable use and reused as mixing gas.

The device can have a set of one or more pressure and/or temperature sensors 35, for example at the second ends 23, 26. These temperature and/or pressure data can be used to automate all or some of the functions, for example for automatic detection of a possible overfilling of the filled tank 5.

This structure allows the elements to be pooled, and in particular allows the number of valves and insulated cryogenic components to be limited. These members can be localized and grouped together in a central part of the circuit. All or some of the valves and sensors are preferably controlled or monitored by a unit remotely.

The device has numerous advantages and in particular allows control and safety equipment (vent 8, sensors 35, valve(s), etc.) to be pooled.

The invention allows the members on board the supply vehicle to be limited to those that are strictly necessary, and therefore allows the density of the system to be maximized, while providing all the necessary main and secondary functions. The device can also be moved easily.

The device can also comprise a compressor for recovering vaporization (boil-off) gas coming from the tank 5 to be filled or from a tank at ambient temperature. This recovered and compressed gas can be used for example to supply a heat exchanger/heater, for example a heater 37 on the first transfer pipe 3.

The device can comprise grounding connections (not shown) between the tanks 4 and/or 5 and the housing 2, in order to ensure that the various items of equipment are at the same potential. The casing or housing 2 can itself be connected to ground.

The device can comprise pneumatic control fluid (in particular nitrogen) connections, which are not shown, between the tanks 4 and/or 5 and the housing 2, in order to allow control from the housing 2, for the purposes of safety and/or the opening and or the closure control for controlling for example valve(s) of the tanks 4 and/or 5. In the same way, a signal (electrical or other) can be established for communicating between the housing 2 and the one or more tanks 4 and 5.

Thus, the device can, if appropriate, have all or some of the following features or functions:
centralized control of the filling/inerting process/of safety management, etc.
use of the return pressure control valve 42 for inerting by dilution and detecting leaks,
a separate inerting capacity for the lines towards the main store 4, for the transfer casing or module 2, for the tank to be filled,
the possibility of placing the tank 5 to be filled under operational conditions (inerting and/or cooling, etc.),
putting the cooling or transfer gases to profitable use as mixing/heating gas,
measuring the gas flow rate, in particular at the outlet of the tank 5 to be filled.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A device for filling with liquefied gas comprising:
a fluid circuit provided with a first pipe for liquid transfer comprising a first end that is intended to be connected to a source of liquefied gas and a second end that is intended to be connected to a tank to be filled, a second pipe for gas transfer comprising a first end that is intended to be connected to the source of liquefied gas and a second end that is intended to be connected to said tank to be filled, at least one third transfer pipe connecting the first and second transfer pipes, a vent device connected to the first and second transfer pipes via a set of one or more safety valves, and a set of one or more valves for controlling streams of fluid in the pipes of the circuit; and
a circuit gas flushing system comprising a first source of pressurized gas, and a first set of one or more flushing pipes connecting the first source of pressurized gas in parallel both to the first and second transfer pipes via a set of one or more valves.

2. The device of claim 1, wherein the flushing system further comprises a second source of pressurized gas and a second set of one or more flushing pipes connecting the second source of pressurized gas in parallel both to the first and second transfer pipes via a set of one or more valves.

3. The device of claim 2, wherein the flushing system further comprises a third source of pressurized gas, in particular hydrogen, and a third set of one or more flushing pipes connecting the third source of pressurized gas in parallel both to the first and second transfer pipes via a set of one or more valves.

4. The device of claim 1, wherein the flushing system further comprises a vacuum pump and a fourth set of one or more flushing pipes connecting the suction member both to the first and second transfer pipes via a set of one or more valves.

5. The device of claim 1, wherein the flushing system further comprises at least one pipe that is common to all or some of the sets of one or more flushing pipes.

6. The device of claim 1, wherein the first pipe for liquid transfer comprises an isolation and/or flow control valve.

7. The device of claim 6, wherein one or more sets of one or more flushing pipes are connected to the first transfer pipe on one side or, or on either side of, the isolation and/or flow control valve of the first pipe for liquid transfer.

8. The device of claim 1, wherein the first pipe for liquid transfer comprises a liquid-gas mixer, a gas source, a gas injection pipe that connects the gas source to the mixer, and a set of one or more valves.

9. The device of claim 1, wherein the device is disposed in a casing or housing and the ends of the first pipe for liquid transfer and the ends of the second pipe for gas transfer are connected to the housing by removable connectors.

10. The device of claim 1, further comprising a source of liquefied gas connected to the first end of the first pipe for liquid transfer and to the first end of the second transfer pipe.

11. The device of claim 1, wherein the second transfer pipe comprises a pressure regulating valve.

12. The device of claim 11, wherein the pressure regulating valve of the second transfer pipe is configured to control the pressure in the tank to be filled, during filling thereof, by controlling the pressure of the gas stream leaving the tank via this second transfer pipe.

13. The device of claim 11, wherein the pressure regulating valve of the second transfer pipe can be closed so as to allow the transfer pipe to be isolated for purposes of performing inerting and/or leaktightness tests.

14. A method for filling a cryogenic fluid tank with liquefied gas using the device of claim 1, the method comprising a step of connecting the tank to the second ends of the first and second transfer pipes, the method comprising a step of transferring liquid into the liquid tank via the first pipe for liquid transfer.

15. The method of claim 14, further comprising at least one of the following steps:
regulating the flow rate of liquid transferred into the tank;
discharging a flow of gas from the tank towards the source via the second transfer pipe;
heating the stream of liquid transferred into the tank during the transfer step by injecting a determined quantity of gas into said stream of liquid; and
discharging excess pressurized gas in the circuit via the vent device.
